(19) United States
(12) Patent Application Publication
(10) Pub. No.: US 2011/0191334 A1
(43) Pub. Date: Aug. 4, 2011

(54) Smart Interface for Color Layout Sensitive Image Search

(75) Inventors: Xian-Sheng Hua, Beijing (CN); Jingdong Wang, Beijing (CN)

(73) Assignee: MICROSOFT CORPORATION, Redmond, WA (US)

(21) Appl. No.: 12/700,613

(22) Filed: Feb. 4, 2010

(51) Int. Cl. G06F 17/30; G06F 3/048

(52) U.S. Cl. 707/726; 715/810; 707/E17.02

(57) ABSTRACT

The present disclosure describes a user interface and techniques to use the user interface to specify user search intent for color layout image search. In one aspect, a user interface is comprised of a color map control, a plurality of controls to draw a color layout, and a drawing canvas upon which to draw. The controls used to draw the color layout include shape preserving and shape modifying operations as wells as editing operations. In this way a color layout may be automatically generated with drawing semantics. The user interface may also be integrated with text search engines that perform text search on text metadata tags associated with digital images.

### BACKGROUND

Computing devices, whether standalone, networked on a local area network (“LAN”), connected to the Internet, or otherwise connected, have been used to search for content such as web pages and documents. Usually the content has been predominantly textual thus allowing for content to be retrieved by matching text keywords to text in the content. Present text search techniques enjoy excellent accuracy with few false positives.

Text search cannot be applied directly to non-textual content such as still images, audio files, and video files. Instead, some efforts have been made to associate textual metadata tags to the non-textual content and to apply text search techniques to the textual metadata. Although text search techniques are generally accurate, their accuracy is compromised by incomplete or inaccurate metadata tagging.

Other efforts, most notably in image search, have been made to enable content-based retrieval. Unlike text search on associated metadata tags, content-based search attempts to analyze the non-textual content directly.

Content-based non-textual search techniques require specifying non-textual attributes. If those non-textual attributes are incompletely or inaccurately specified, then the accuracy of the non-textual search technique will be consequently compromised. Accordingly, a user interface (“UI”) that enables accurate and complete specification of non-textual attributes would enhance the accuracy of content-based non-textual search.

### SUMMARY

This application discloses color layout UI elements, and techniques to apply those color layout UI elements to the search of digital images. Specifically, the color layout UI elements include, but are not limited to: (1) a color map control that specifies a color layout, (2) a plurality of controls to draw the color layout, and (3) a canvas on which to draw the color layout. The techniques include specifying a color layout with the color layout UI elements, calculating similarity scores, retrieving and ranking digital images, and displaying the retrieved and ranked digital images.

The techniques further include using a plurality of controls to draw the color layout on a color map control, which in turn automatically generates the color layout values. The plurality of controls include, but are not limited to: (1) a color stroke scribble free drawing control, (2) a blob template control, (3) controls to specify colors and color effects such as linear and radial gradients, (4) anchor points to translate, and transform portions of the color layout, (5) controls to drag and drop existing images to the color map control, and (6) editing controls. The techniques include optimizations to manage color palettes.

The color layout UI is implemented on a computer system in software, firmware, or equivalent. The color layout UI is extensible via an application programming interface (“API”) to permit third party similarity scores, and third party rules and heuristics to be available for utilization by the color layout UI. The API may comprise a programmatic library including, but not limited to function calls, custom data types, objects and their associated properties, methods, and events. Accordingly, similarity scores and heuristics may be implemented in the API and compiled into modules accessible by the color layout UI and the color layout image search engine. The color layout UI has logging functions for audit, diagnosis, and optimization purposes.

The color layout UI may be used as the sole means of specifying images to search or may be supplemented with other search criteria systems such as text keywords used to search to text metadata tags associated with digital images. Since the color layout UI specifies colors, and digital image text metadata tags may include text names of colors, the color layout UI may also convert colors specified in the color layout into their text names, and utilize the text names of the colors as part of a text search on the digital images.

This summary is provided to introduce concepts relating to contextual image search. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

Non-limiting and non-exhaustive examples are described with reference to the following figures. In the figures, the left-most digit(s) of a reference number identifies the Fig. in which the reference number first appears. The use of the same reference numbers in different figures indicates similar or identical items or features.

FIG. 1 illustrates an exemplary end to end operation of the color layout UI.

FIG. 2 illustrates an exemplary hardware environment of the color layout UI.

FIG. 3 illustrates an exemplary user interface for color layout image search.

FIG. 4 is a flowchart illustrating one embodiment of a technique to manipulate blobs in the color layout UI.

FIG. 5 illustrates one embodiment of a blob template bar.

FIG. 6 illustrates one embodiment of anchor points used to select a blob, and to color fill the selected blob and to apply color effects to the selected blob.

FIG. 7 illustrates one embodiment of anchor points used to select a blob, and transform and translate the selected blob.

### DETAILED DESCRIPTION

### Color Layouts and Color Layout Image Search

One form of digital image search by content is to specify a color layout. A color layout is composed of a grid of boxes, each of which holds a color. A digital image's color layout may be created by superimposing a grid over the image, and storing values for each box corresponding to the predominant color of the digital image at the box's location. Accordingly, a color layout populated with colors by a user may then be compared to the color layouts of a set of stored digital images. The digital images whose color layouts most closely match the color layout specified by the user may then be presented. This process is known as color layout image search.

An example of a color layout is to create an 8×8 grid of boxes. If we are searching for digital images with blue sky at the top and sand at the bottom, one might color the first row of the box with sky blue and color the bottom row with tan or some other sand-like color. Applying this color layout to a color layout image search would retrieve all stored digital images that were searched, whose top eighth was close to sky blue and whose bottom eighth was close to tan. Because the middle six rows were not specified, digital images retrieved could have any color corresponding to those locations.

There are multiple schemes to specify the color value in the grid boxes of a color layout. One scheme, called RGB, is to concatenate three 256 bit values, each corresponding to the amount of red, the amount of green, and the amount of blue contributing to the color to be coded. Another scheme, called HLS is to concatenate three 256 bit values, each corresponding to the hue, luminosity, and saturation contributing to the color to be coded. There are schemes that take into account techniques to compress RGB and HLS values. Regardless of the scheme, a color value stored in a color layout may then be compared to another color layout for equivalence, or a similarity score calculated.

Specifying a color layout manually is a time intensive task. The color layout UI automatically calculates these color layout values and the color layouts after a user draws a color layout on a color map control. These color layouts may then be input into a color layout image search engine to perform an image search.

The color layout UI is not necessarily specific to a color layout image search engine. The color layout UI may also have color layouts converted into other forms for integration with other types of search engines. For example, the distinct colors in a color layout may be identified, the text names of those colors converted into keyword input into a text search engine. The text search engine would then retrieve stored digital images whose text metadata tags included the text names of colors in those respective images.

The color layout UI may be supplemented with a standard text search function that applies inputted keywords to text metadata associated with stored digital images. Alternatively, a pass where the color layout UI generated a list of text names of colors to be used as keywords in a text based image search as described above may be used as a first pass that reduces the number of digital images to be searched by a subsequent color layout content based image search. These are merely two examples of how a color layout UI may be integrated with a text search engine.

### Exemplary End to End Operation of Color Layout Image Search

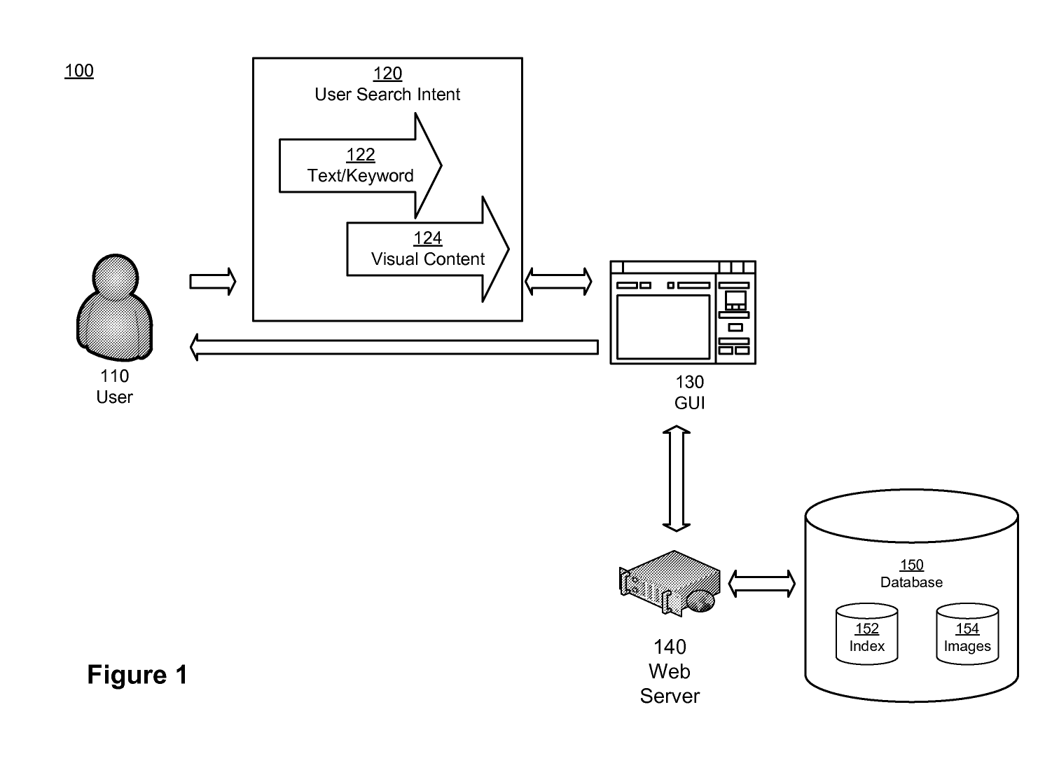

FIG. 1 illustrates an exemplary end to end operation 100 of a color layout UI used alone on color layout image search or alternatively integrated with another form of image search.

User 110 has a particular set of digital images he seeks to search for and retrieve. These desired digital images are called the user search intent 120 and may be expressed in several ways. It may be expressed as text 122, usually in the form of keywords, or it may be expressed as visual content 124 such as image color layouts. The user search intent 120 may also be expressed as a combination of text 122 or visual content 124.

The user search intent 120 is entered into a graphical user interface (“GUI”) 130. The GUI may be hosted in a web browser, but may also be hosted as part of a windowed application. In 100, the GUI 130 sends a hypertext transfer protocol (“HTTP”) request to a web server 140 which hosts an application to query a store of digital images to be search, here in a database 150. Database 150 may store digital images 154 as well as indexes 152 to optimize search and retrieval of the digital images.

The application on the web server 140 processes the user search intent 120 as expressed in the GUI 130 by querying the database. Upon database 150 retrieving digital images satisfying the query, the results are returned to the application on the web server 140.

The application on the web server 140 may include modules that include similarity scores and heuristics. Similarity scores modules encode functions that calculate a value indicating to what extent a retrieved digital image is similar to the expressed user search intent 120. Retrieved images that satisfy some threshold predetermined or otherwise, may be then presented to a user. There are a number of similarity scores well known in the art.

Because some similarity score calculations are computationally intensive, heuristics may also be applied to limit the number of images where a similarity score is calculated.

The application on the web server 140 may expose an application programming interface (“API”) by which similarity score modules and heuristic modules may be programmed. Since any party that writes to the API may program a similarity score or heuristic model, the API provides an extensibility model by the user or other third parties can expand and improve the content layout image search results. APIs may be exposed via many mechanisms including, but not limited to, dynamic link libraries, static libraries, and Common Object Model (“COM”) libraries.

Once the application on the web server 140 extracts which of the retrieved digital images are to be displayed, it may rank the digital images to be displayed. At this stage, the calculated similarity scores corresponding to the digital images may be used to sort the digital images from most similar to least similar.

The application on the web server 140 then generates a hypertext markup language (“HTML”) page to present the retrieved images. The user 110 then views these retrieved images on the GUI 130 for review.

The application on the web server 140 may store indicia of the each of the aforementioned operations for logging purposes. The indicia of the user search intent may be the keywords and the color layout. The indicia of the retrieved images may be a sample list of identifiers of the images retrieved. The indicia of the similarity scores and ranking may be an identifier of the similarity score used and identifiers for any heuristics applied. Additional statistical data such as the size of the resultset of the retrieved digital images and the length of time for the operation to perform may also be logged. Errors such as time outs or system failures may also be logged.

The logging may be in the form of a text file, or alternatively may be in the form of a series of records stored either in database 150 or some other data store. In this way, the logs may be later examined for audit, diagnosis, and optimization purposes.

### Exemplary Hardware Environment

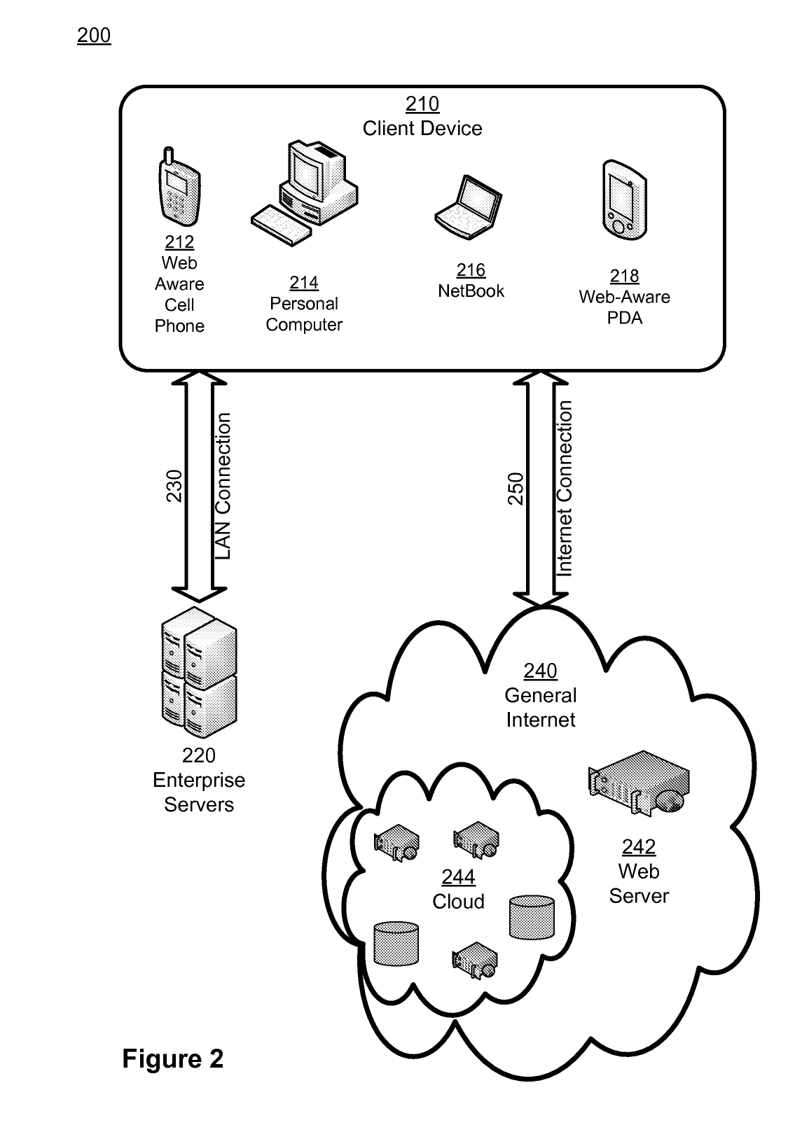

FIG. 2 illustrates an exemplary hardware environment 200 for the color layout image search and color layout UI.

The color layout UI is capable of being hosted on a wide range of client devices 210. If the color layout UI is embodied in a web page, the client device may be any web-aware client, including but not limited to a cell phone 212, personal computer (“PC”) 214, netbook 216, or web aware personal device assistant (“PDA”) 218. If the color layout UI is embodied in a windowed application, it may be hosted on a PC 214 or netbook 216. PC 214 may include any device of the standard PC architecture, or may include alternative personal computers such as the MacIntosh™ from Apple Computer™, or workstations including but not limited to UNIX workstations.

The color layout UI on a client device 210 may then access a color layout image search engine or other search engine hosted on an enterprise server 220 or a server hosted on the general internet 230.

If the color layout UI is accessing an enterprise server 220 on a local area network (“LAN”), it may connect via any number of LAN connectivity configurations 230. At the physical layer this may include Ethernet™ or Wi-Fi™. At the network/session/transport layer this may include connectivity via the Transmission Control Protocol/Internet Protocol (“TCP/IP”) or other protocol. If the color layout UI is accessing the internet, it may connect via standard internet protocols including TCP/IP for the network/session/transport layer and Hypertext Transfer Protocol (“HTTP”) at the application layer.

Enterprise server 220 may be based on a standard PC architecture, or on a mainframe.

If accessing the general internet 230, an independently hosted web server 242 may be accessed. A web server 242 may be a standard enterprise server based on a standard PC architecture that hosts an application server. Exemplary application server software include Internet Information Server™ (“IIS”) from Microsoft Corporation™ or Apache Web Server, an open source application server. Web server 242 may access a database server also potentially on a standard PC architecture hosting a database. Exemplary databases include, Microsoft SQL Server™ and Oracle™. In this way a color layout image search engine may run on 2-tier or 3-tier platforms.

Alternatively, the color layout image search engine may be hosted on a cloud computing service 244. Cloud computing service 244 contains a large number of servers and other computing assets potentially in geographically disparate locations. These computing assets may be disaggregated into their constituent CPUs, memory, long term storage, and other component computing assets. Accordingly, the color layout image search engine, when hosted on cloud computing service 244, would have both centralized and distributed data storage on the cloud, accessible via a data access API such as Open Database Connectivity (“ODBC”) or ADO.Net™ from Microsoft Corporation™. The application portions of the color layout image search engine would be hosted on computing assets in the cloud computing service 244 corresponding to an application server.

### Exemplary Color Layout User Interface

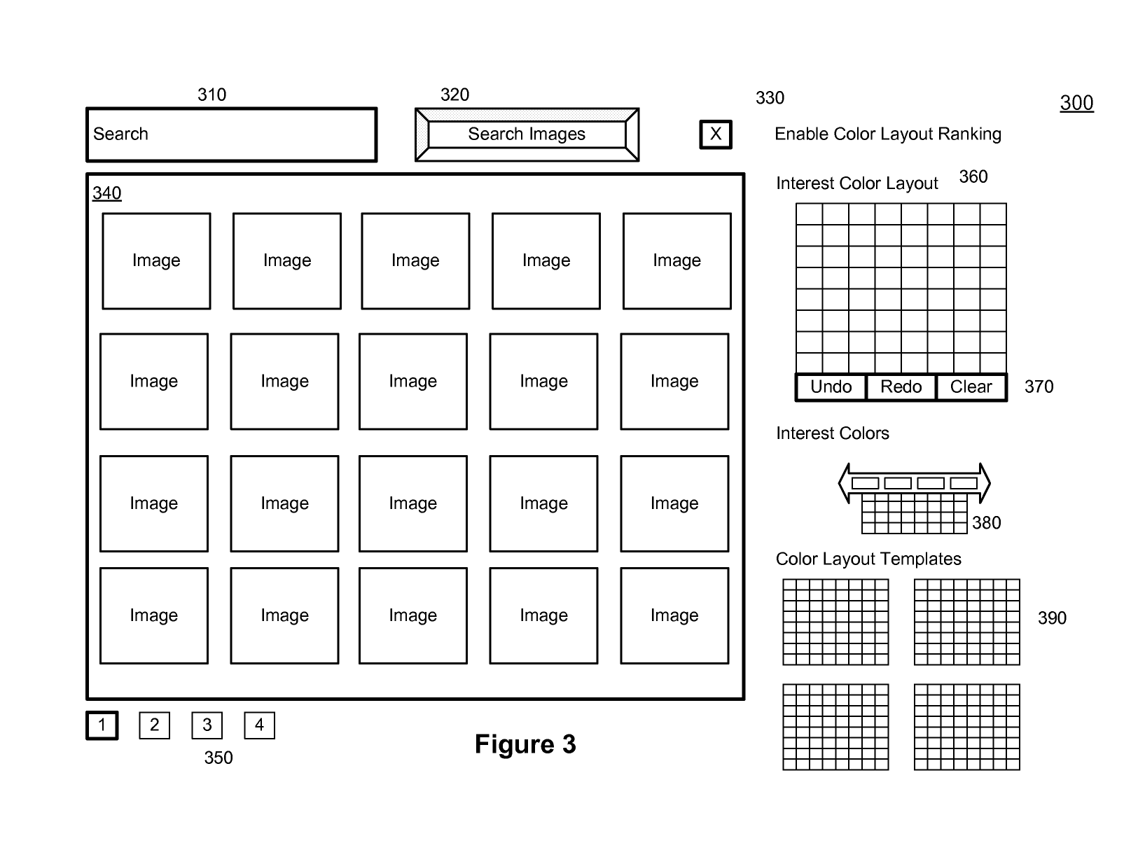

FIG. 3 illustrates an exemplary color layout UI 300.

In 300, the color layout user interface may be used strictly for generating color layouts for color layout image search, or may be used in conjunction with a text search engine. Accordingly, text keywords may be entered in text box 310. Upon entry, search button 320 may be clicked on to trigger image retrieval.

Check box 330 allows a user to indicate if the image search is to be: (1) text only, (2) color layout image search supplemented with text, or (3) color layout image search alone. If check box 330 is not checked, the search is to be text only with keywords applied to text metadata tags applied to stored images to be searched. If check box 330 is checked, then any keywords entered into text box 310 will supplement the operation of the color layout image search. If check box 330 is checked, but no keywords are entered into text box 310, then the effect is for the search to be solely via color layout image search.

In any of the above three options, the retrieved images are displayed in palette 340. In this exemplary color layout UI 300, the images displayed as thumbnail images which may be clicked on for further review. Where more than one page of images is available, links or buttons 350 may be clicked to scroll through the pages to view the rest of the retrieved images.

Color map control 360 allows a user to specify a color layout. In this exemplary embodiment 300, the color layout is an 8×8 grid. Each of the boxes of the grid has a location, and may have a color value specified. If the color value is not specified, then the box may take any color. Instead of having to calculate and generate a color layout by hand, a user may simply draw the colors on the color map control 360, and the color map control 360 will automatically generate the color layout.

Alternatively, the color layout may be 16×16 or some other byte-aligned dimension, assuming 8-bit bytes. The color layout need not be byte aligned, and for example be 12×12. In both the 16×16 and 12×12 cases, higher fidelity than 8×8 is achieved. The color layout grid need not have the same dimensions. For example, the grid may be 16×12 or 16×9 in order to better represent 4-3 and 16-9 aspect ratios as in video.

One drawing capability is called color stroke scribble, or free drawing. A cursor has a color associated. A user may then use pointing device semantics such as a point and click with a mouse or pen pad, to draw points and strokes with that associated color.

Operation bar 370 provides editing and other functions. This exemplary embodiment 300 illustrates the “undo” and “redo” functions which undo the last stroke or restore and undone stroke. Also this exemplary embodiment 300 illustrates the “clear” function which sets the entire color map control 360 to having no color values set in any box location. Other functions include “copy” which allows a bounding box to be drawn over a portion of the color map control 360, the contents buffered, and “paste” which reapply the buffered contents into another location of the color map control 360. A similar operation, “cut”, operates like “copy” except the contents of the bounding box are cleared upon the contents being pasted. Other functions may include administrative commands such as to store the color layout as a template. The color layout templates are shown in color layout template control 390 in this exemplary UI 300. Color layout templates shown in color layout template control 390 may be used as starting points for a color layout used for another search by selecting a color layout template from color layout template control 390 and dragging and dropping it to the color map control 360. This is called color layout template selection.

In addition to dragging and dropping color layout templates from color layout template control, returned images may be selected from canvas 340 and dragged and dropped to the color map. Upon being dragged and dropped onto the color map, the image will be scaled to fit into the color map. The image may be stretched or alternatively letterboxed to fit into the color map dimensions. For example, if the color map is grid 8×8 box locations, the dragged and dropped image is scaled, stretched or letterboxed, and superimposed over the color map. For each box location one or more particular colors that approximate the color in the corresponding box location of the dragged and dropped image are values set in the color map. This operation is called an image drag and drop, and the control may be known as an image drag and drop control. Note that image drag and drop operations may be combined with color stroke scribbling operations or other operations. The result of such combined operations is called a mixed target color map.

Note that the operation bar need not be a bar as displayed in 300. The operations may be presented in drop down menus, context menus, in a pop-up toolbox dialog, or any other user interface where multiple operations may be viewed and selected.

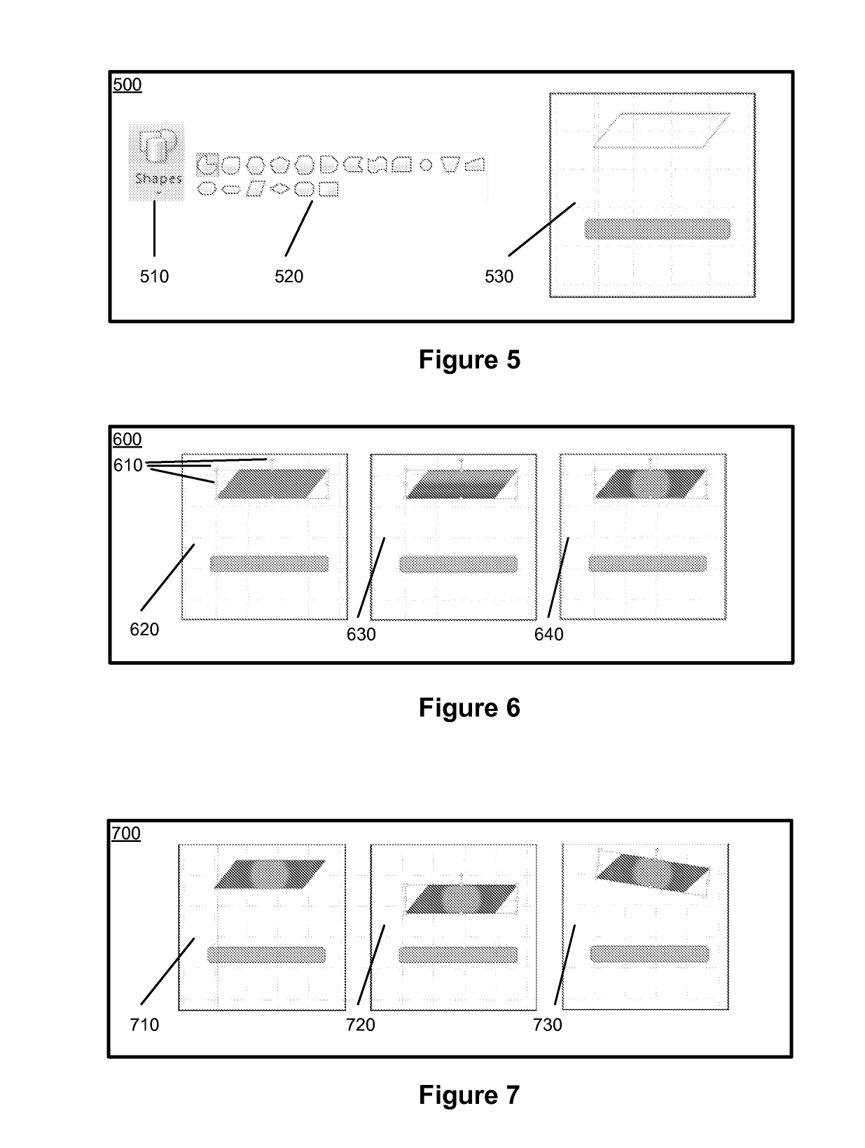

Alternatively, the operation bar may display a blob template control, which displays a range of shapes that may be drawn on the color map control 360. Typical example shapes are ovals and rectangles. The blob template control facilitates drawing on the color map control 360. The blob template control is described in reference to FIG. 5 below.

The operation bar may also include an operation to display color effects. Specifically, where a closed shape, such as an oval or rectangle has been drawn via the blob template control, a user may fill the closed shape with a color, a pattern, or a color effect. Color effects are described in reference to FIG. 6 below.

Colors may be selected via a color palette 380. In this exemplary embodiment 300, the color palette 380 displays 64 colors in an 8×8 grid. By clicking on one of the colors displayed in the 8×8 grid, a user may change the color applied by the color stroke scribble control, blob template control, or by some other drawing control.

The color palette need not be 8×8 and need not be a grid. For example, the color palette may be 12×12 or 12×8 depending on the number of colors to be viewed. The color palette may come in the form of a color wheel, scrollable window or any user interface where multiple colors may be viewed and selected.

Since the range of colors available in digital images are very large, most recently used colors may be buffered and displayed or scrolled in the arrowed bar above the color palette 380. Whenever a color is selected in a palette, the color is added to a list. The most recently used colors are displayed in the arrow control. In this exemplary UI 300, only four colors are shown. If a user wishes to see other colors previously used, he may scroll left or right by clicking on the corresponding arrow. Upon finding the desired recently used color, the user may click on the color to select that color.

The range of colors available in digital images will exceed the 64 colors used in this exemplary UI 300. However, displaying a large number of colors will take up a disproportionately large amount of UI screen space. The color palette 380 might alternatively display a toggle button where when clicked, the 64 color grid is replaced by a grid of 144 colors for example. The 64 color grid would be considered a “coarse grain” color palette and the 144 color grid would be considered a “fine grain” color palette. When the user had selected the desired color from, the fine grain color palette, the user may click on the toggle button to remove the fine grain color palette and replace with the coarse grain palette. In this way, the screen space to search through a larger amount of colors is used only when needed to browse colors.

A key strength of a color map control 360 is the capability to convert drawing semantics commonly known to a user into a color layout. Because the color map control 360 is responsible for generating the user search intent, the user search intent may be optimized. In one optimization, because image queries make use of similarity scores rather than exact matches, the color layout need not be of the exact color of the image to be searched. Accordingly, the color map control 360 need not maintain a large number of colors, but rather a relatively small sampling of colors. Thus the color map control 360 may generate a color layout from the small sampling. By querying images where their associated color layout is populated not with their exact color values, but rather with the values with the closest fit, smaller amounts of memory and simpler similarity scores may be used. In turn, less computing is required and search performance is faster.

The color map control 360 need not generate a color layout. The color map control 360 may be integrated with a text engine configured to search metadata tags associated with digital images to be searched. In this scenario, the color map control 360 identifies the distinct colors in the color layout specified by a user. The color map control 360 then generates a list of keywords corresponding to the names of the colors and then submits it to the text search engine. The text search engine then searches for digital images with metadata tags that match the list of keywords and returns those results. For example, a user searching for a U.S. flag may draw a color layout on the color map control 360 with red, white, and blue colors. The color map control 360 creates a list with the keywords “red”, “white”, and “blue.” Assuming the images to be searched are tagged with metadata including text names of the colors in the images to be searched, any images tagged with “red”, “white”, and “blue” may be retrieved. It is noted that in this color layout to text conversion, the color location information is lost. However, this provides an example of integrating a color layout UI with search engines other than a color layout image search engine. In some scenarios, this technique may be used as a first pass heuristic to limit the items to apply a similarity score to, and thereby reduce false positives.

### Blob Manipulation

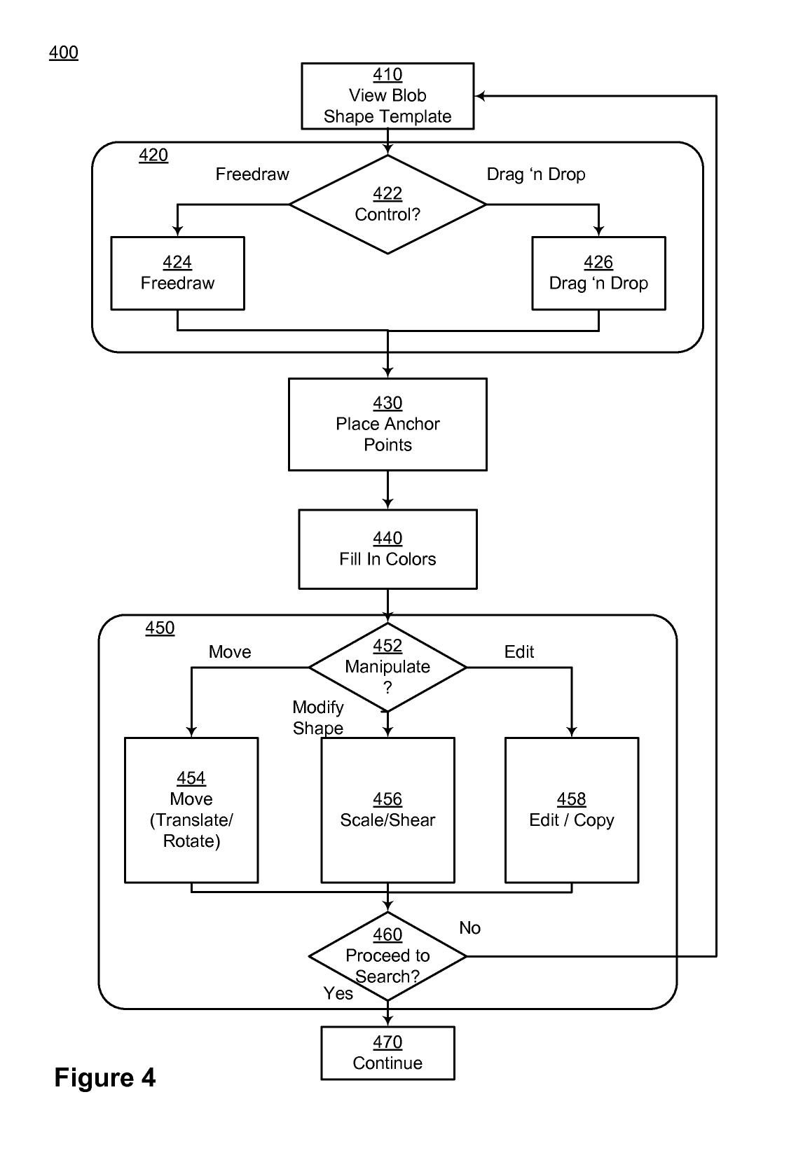

The ability to place predefined shapes on the color map control 360, such as ovals and rectangles was introduced in the discussion about the operation bar above. In this application, the functions to draw and manipulate those shapes in the color map control 360 are called blob manipulation, and the control to perform these operations is called a blob shape template or a blob template control. FIG. 4 illustrates one exemplary method of blob manipulation 400. FIGS. 5-7 provide illustrations of the effects of the blob manipulations described in reference to FIG. 4.

In step 410, a user activates or views a blob template control. An exemplary blob template control is illustrated in FIG. 5. Drop down box 510 when clicked displays different sets of shapes or blobs. Blob template 520 comprises a set of shapes. When a blob template shape on blob template 520 is selected, that shape may be drawn on the color map control 360. In this example, in color layout 530, a parallelogram and a rectangle have been drawn. When the parallelogram was drawn, the color selected in color palette 380 was white. When the rectangle was drawn, the color selected in color palette 380 was green. Accordingly, the parallelogram and the rectangle are white and green respectively.

In step 420, a user selects what type of control mode to draw in 422. The user may opt to free draw 424, for example using the color stroke scribble control. In this option, the user may draw a freehand closed shape, such as an irregular star. Alternatively, the user may drag and drop 426 a shape from the blob template 520.

The user may then manipulate the shape drawn or placed into the color map control 360. The shape may be selected, for example by clicking. To indicate that the shape has been selected, it may be highlighted or bordered. In the illustration of shape selection and coloring 600 in FIG. 6, selection is indicated by the drawing of anchor points 610. Specifically, when a shape or blob is selected, a dotted bounding box for that shape is drawn. Anchor points 610 are drawn on the around the bounding box. In this illustration 600, the transformation and translation anchor points are on the corners and the midpoints of the bounding box. A rotational anchor point is drawn offset from the top of the bounding box.

In 440, a user may apply color effects to selected shape or blob. FIG. 6 illustrates some exemplary effects. In 620, a shape may be color filled. A color is selected from color palette 370, and upon clicking a button on the operation bar specifying color fill, the selected color solidly fills in all the space bounded by the selected shape. In 630, the shape is filled in with a linear gradient pattern. A color is selected from color palette 370 and upon clicking a button on the operation bar specifying linear gradient, the shape fills in with the selected color scaled to white along a line. In this example 630, the lines are horizontal. Alternatively, instead of scaling to white, a secondary color may be specified as well. In 640, the shape is filled in with a radial gradient pattern. A color is selected from color palette 370 and upon clicking a button on the operation bar specifying radial gradient, the shape fills in with the selected color scaled to white radiating from a point. In this example 640, the point radiates out from the center of the shape. As with 630, with radial gradient 640, instead of scaling to white, a secondary color may be specified as well.

In 450 the user select 452 may move, modify, or edit the selected shape. Moving options 454 include translation effects and rotational effects. FIG. 7 illustrates those effects. Item 710 illustrates the initial state of a color layout map 360 with a white parallelogram and a green trapezoid. With translation, as shown in 720, the selected shape maintains its size and orientation, but is moved to a new location. With rotation, in 730, again the selected shape maintains its size and orientation, but here is rotated about a point.

Shape modifying options 456, includes scaling and shearing operations. In scaling, the size of the selected shape is either increased or decreased. Because the resizing is proportional, the shape retains a geometrically similar shape. With shearing, an anchor point corner or side of the bounding box is moved while the other anchor points stay static. The shape is then stretched to fit into the new bounding trapezoid. If a midpoint anchor is moved, then the shape is simply stretched along a line. In all three examples, the selected shape does not retain its shape.

In mathematical terminology, resizing, shearing, along with rotation are consider linear transformations (so-called because of the underlying matrix operators used to perform the transformations).

Editing options 458 include, but are not limited to, the “undo”, “redo”, “cut”, “copy” and “paste” operations as discussed above.

In 460, a user may opt to continue editing. If so, operation returns to 410. If a user is done, the user may proceed to 470 to continue. At this point, the user may stores the completed color layout as a color layout template.

The user may generally execute a search using the complete color layout as part of the input to a color layout image search. At this point, the color control 360 automatically calculates the values for a color layout and then performs a color layout image search. If the search engine to be used is not a color layout image search engine, then the color map control 360 generates the user search intent information appropriate for the search engine. In any of these cases, the color map control 360 has automatically converted user search intent information via drawing semantics, into user search intent information appropriate for an image search engine.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method to manipulate a digital image search user intent specification operative on a set of stored digital images, the method comprising:
displaying a graphical user interface, the graphical user interface comprising a color map, a plurality of controls, and a canvas;
receiving user intent search input via at least one of the plurality of controls, the user intent search input comprising manipulating the color map via at least one of the plurality of controls;
storing values corresponding to the user intent search input;
calculating respective similarity scores of at least some of the stored digital images based on at least some of the stored values;
ranking the at least some of the stored digital images based on at least the respective calculated similarity scores; and
displaying on the canvas at least some of the ranked digital images based at least on the ranking.

2. The method of claim 1, wherein the color map comprises a plurality of locations, each location set to a particular color,
wherein the displayed plurality of controls comprise a free drawing control, and
wherein the receiving user intent search input comprises selecting a particular color for at least one location in the color map.

3. The method of claim 1, wherein the displayed plurality of controls comprise a blob template control, the blob template control displaying a plurality of blobs for selection, and
wherein the receiving user intent search input comprises:
selecting one of the plurality of blobs via the blob template control, and
displaying the selected blob in the color map.

4. The method of claim 3, wherein the displayed plurality of controls further comprise a color control, the color control displaying a plurality of selectable color samples, and
wherein the receiving user intent search input comprises:
selecting a color sample from the plurality of selectable color samples,
selecting a blob displayed in the color map, and
setting all locations within the selected displayed blob to the selected color sample.

5. The method of claim 4, wherein the selecting a color sample comprises storing the selected color sample in a list of recently used color samples, and
wherein the plurality of selectable color samples displayed by the color control include at least one color sample from the list of recently used color samples.

6. The method of claim 3, wherein the displayed plurality of controls further comprise a color effects control, the color effects control displaying a plurality of selectable color samples, and
wherein the receiving user intent search input comprises:
selecting two color samples from the plurality of selectable color samples,
selecting a blob displayed in the color map, and
setting all locations within the selected displayed blob to one of the two selected color samples or a gradient value between the two selected color samples.

7. The method of claim 3, wherein the displayed plurality of controls comprise a color switch, the color switch having:
a first plurality of selectable color samples and a second plurality of color samples, only one of which may be displayed at a time, and
a toggle control to switch between displaying the first plurality of selectable color samples and the second plurality of color samples, wherein
the receiving user intent search input further comprises:
displaying the first plurality of selectable color samples,
selecting a first color sample from the displayed first plurality of selectable color samples,
toggling the toggle control to switch to remove the first plurality of selectable color samples and to display the second plurality of selectable color samples, and
selecting a second color sample from the displayed second plurality of selectable color samples.

8. The method of claim 3, wherein the color map comprises a plurality of locations, each location set to a particular color, and
wherein the displaying the selected blob in the color map comprises:
displaying anchor points associated with the selected displayed blob, and
manipulating the selected displayed blob by moving the associated displayed anchor points.

9. The method of claim 8, wherein the manipulating the selected displayed blob comprises translating the locations within the anchor points associated with the selected displayed blob.

10. The method of claim 8, wherein the manipulating the selected displayed blob comprises transforming the locations within the anchor points associated with the selected displayed blob.

11. The method of claim 1, wherein the displayed plurality of controls comprise an image drag and drop control, and
wherein the receiving user intent search input comprises:
selecting an digital image from the canvas,
dragging and dropping the selected digital image onto the color map,
scaling the selected digital image to match the dimensions of the color map, and
displaying the scaled selected digital image in the color map.

12. The method of claim 1, wherein the displayed plurality of controls comprise a color layout template selection control, and
wherein the receiving user intent search input comprises:
selecting a color layout template from the color template selection control,
dragging and dropping the selected color layout template onto the color map, and
displaying the selected color layout template in the color map.

13. The method of claim 1, wherein the displayed plurality of controls comprise an operation bar displaying at least one selectable editing operation.

14. The method of claim 13, wherein the at least one selectable editing operation is one of a move operation, a remove operation, and a copy operation.

15. The method of claim 1, wherein at least some of the stored digital images are associated with text metadata,
wherein the displayed plurality of controls comprise a control to receive text keywords, and
wherein the ranking the at least some of the stored digital images is additionally based on a similarity of the received text keywords to the respective text metadata of each stored digital image.

16. The method of claim 1, wherein at least some of the stored digital images are associated with text metadata comprising the names of colors in each respective stored digital image,
wherein the color map comprises a plurality of locations, each location set to a particular color, and a list of the text names of the distinct particular colors in the color map locations, and
wherein the ranking the at least some of the stored digital images is additionally based on similarity of the list of text names of the distinct particular colors in the color map locations to the respective text metadata of each stored digital image.

17. The method of claim 1, further comprising:
logging indicia of at least the receiving user intent, the calculating respective similarity scores, and the ranking the at least some of the stored digital images to persistent storage.

18. A computer-implemented system, comprising:
a processor; and
memory to store computer-executable instructions that, when executed by the processor, to perform a method to manipulate a digital image search user intent specification operative on a set of stored digital images, the method comprising:
displaying a graphical user interface, the graphical user interface comprising a color map, a plurality of controls, and a canvas;
receiving user intent search input via at least one of the plurality of controls, the user intent search input comprising manipulating the color map via at least one of the plurality of controls;
storing values corresponding to the user intent search input;
calculating respective similarity scores of at least some of the stored digital images based on at least some of the stored values;
ranking the at least some of the stored digital images based on at least the respective calculated similarity scores; and
displaying on the canvas at least some of the ranked digital images based at least on the ranking.

19. The system of claim 18, further comprising:
an application programming interface, and
an external similarity score module implemented in the application programming interface,
wherein the external similarity score module contains computer-executable instructions to calculate respective similarity scores of at least some of the stored digital images.

20. A computer-implemented system, comprising:
a processor; and
memory to store computer-executable instructions that, when executed by the processor, to perform a method to manipulate a digital image search user intent specification operative on a set of stored digital images wherein at least some of the stored digital images are associated with text metadata, the method comprising:
displaying a graphical user interface, the graphical user interface comprising a color map, a plurality of controls, and a canvas;
receiving user intent search input via at least one of the plurality of controls, the user intent search input comprising (1) manipulating the color map via at least one of the plurality of controls and (2) receiving text keywords via at least one of the plurality of controls;
storing values corresponding to the user intent search input;
calculating respective similarity scores of at least some of the stored digital images based on at least some of the stored values;
ranking the at least some of the stored digital images based on at least the respective calculated similarity scores, and on a similarity of the received text keywords to the respective text metadata of each stored digital image; and
displaying on the canvas at least some of the ranked digital images based at least on the ranking.
